(19) United States
(12) Patent Application Publication
(10) Pub. No.: US 2016/0327047 A1
(43) Pub. Date: Nov. 10, 2016

(54) SELFPRIMING SYSTEM HAVING VALVE FOR A CENTRIFUGAL PUMP

(71) Applicant: RIO BOXX HOLDING B.V., Utrecht (NL)

(72) Inventor: Sam SPEIJERS, Utrecht (NL)

(73) Assignee: RIO BOXX HOLDING B.V., Utrecht (NL)

(21) Appl. No.: 15/110,253

(22) PCT Filed: Jan. 9, 2015
(86) PCT No.: PCT/NL2015/050014

§ 371 Date: Jul. 7, 2016

(30) Foreign Application Priority Data
Jan. 24, 2014 (NL) 2012135

(51) Int. Cl. F04D 9/04; F04D 13/12; F04D 15/00; F16K 33/00; F04C 11/00; F04C 14/24; F16K 31/22; F04D 1/00; F04C 2/34

(52) U.S. Cl. CPC F04D 9/041; F04D 1/00; F04D 13/12; F04D 15/0005; F04C 2/34; F04C 11/005; F04C 14/24; F16K 31/22; F16K 33/00

(57) ABSTRACT

A system including a not self-priming medium pump including a pump head for supply of medium, a valve coupled to the pump head and which includes a passage operated by a float, and an air pump connected to the valve. The system controls the level of the medium in the pump head by the float. The float is shaped such that, when the pump head is filled with medium, an increasing upward force of the float is sufficient to close the passage in time. By virtue of optimized timing of, in particular, the closing, but also the opening, of the passage, both efficiency of the medium pump and service life of the air pump are improved, while the system is self-priming.

The present invention relates to a system as described in the pre-amble of claim 1.

The present invention also relates to a valve according to claim 14, which can suitably be used in such a system.

Such a system and such a valve are disclosed in US-2002/0168270 A1. The pump system disclosed therein is configured as an eventually self-priming system comprising a centrifugal pump for fluids, a valve being mounted on the pump head with adjoining supply to the eye of the pump. On the upper side of the conical valve housing, a vacuum pump is connected on one side of the closable passage, and a valve body which, through a tappet, is operated so as to be axially movable by an initially freely suspended spherical float is situated on the other side of the passage, which float keeps the passage open. In operation, the vacuum pump draws in air via the passage and if this causes the level of the fluid in the valve housing to rise, the fluid will contact the spherical float, as a result of which, when the float sinks deeper into the fluid, said float will be lifted under the influence of a gradually increasing force, causing the valve body to close the passage. If the fluid in the pump head is at a level at which the eye is covered with water, the centrifugal pump is able to start pumping. If the supply of fluid stagnates and more and more air accumulates in the valve housing, the eye will no longer be covered with water, causing the pumping of fluid to stop. The increase of air in the valve housing causes the float to drop, thereby opening the passage, and enabling the air to be drawn out of the valve housing by the vacuum pump. Upon opening and closing of the valve, a possibly desirable hysteresis is observed with respect to the instants at which said opening and closing is initiated when the eye is at minimum fluid levels in the valve housing.

A general problem of such systems resides in that the centrifugal pump used as a medium pump is not self-priming and therefore requires a liquid level that reaches up to the eye, whereas an air or vacuum pump, by contrast, cannot be used in combination with fluids. The system according to the prior art does not adequately solve this problem, so that, on the one hand, the efficiency of the medium pump is sub-optimal and, on the other hand, the service life of the air pump leaves to be desired.

It is an object of the present invention to provide a system which through simple measures makes improvements on the points mentioned hereinabove.

To achieve this, the system according to the invention is characterized in that the float is shaped such that, when the pump head is filled with medium, the increasing upward force of the float is sufficient to close the passage in time.

The inventor has realized that in order to enable the individual pumps of the system and the system as a whole to function optimally, it is important that the combined action dictated by controlling the passage is optimal. In other words, timing is of essential importance, and from this it follows naturally that it is important that appropriate action is taken particularly in the process of closing the valve passage. By shaping the float such that the upward force growing from the start increases sufficiently rapidly and is strong enough to enable closing of the passage, said passage can be timely opened and closed automatically without medium being drawn into the air pump and without the use of all sorts of artificial measures and electronic means. By virtue thereof, the air pump remains free of medium and more optimal functioning of the medium pump within the scope of operation thereof is achieved in this self-priming system according to the invention.

An embodiment of the system according to the invention is characterized in that the valve comprises a flexible valve body which is movably actuated by the float through a tappet, which valve body serves to successively open or close the apertures.

An advantage of this embodiment of the system according to the invention resides in that said successive opening or closing of the apertures, which in practice have different sectional dimensions, different mutual distances or patterns, and which embodiment is balanced by the self-weight of the motion mechanism in the valve and the properties of the medium, can take place as vibrationless and noiseless as possible.

A further embodiment of the system according to the invention is characterized in that the system comprises medium-supply pipes originating from separate sources, which pipes are jointly connected to the pump head of the medium pump usually through sensor-controlled valves.

By means of this embodiment the foundation is laid of a versatile pump system which is multifunctionally applicable in combination with various separated media and media which can be kept separated, and which requires only one and the same medium pump of the system according to the invention.

Further detailed, possible embodiments, which are set forth in the remaining claims, are mentioned together with the associated advantages in the following description.

The system and the valve according to the present invention will now be explained in greater detail with reference to the figures mentioned below, in which corresponding parts are indicated by means of the same reference numerals. In the Figures:

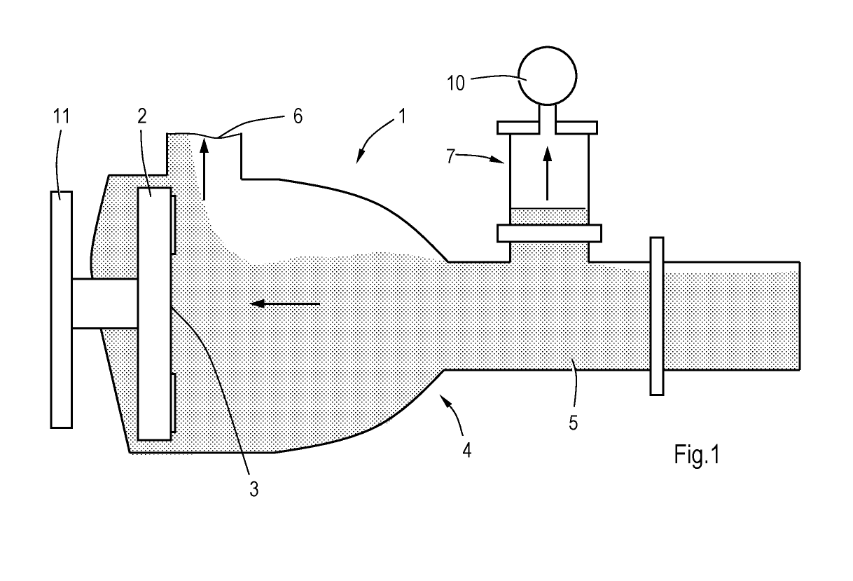

FIG. 1 is a schematic representation of a pump system which is known per se;

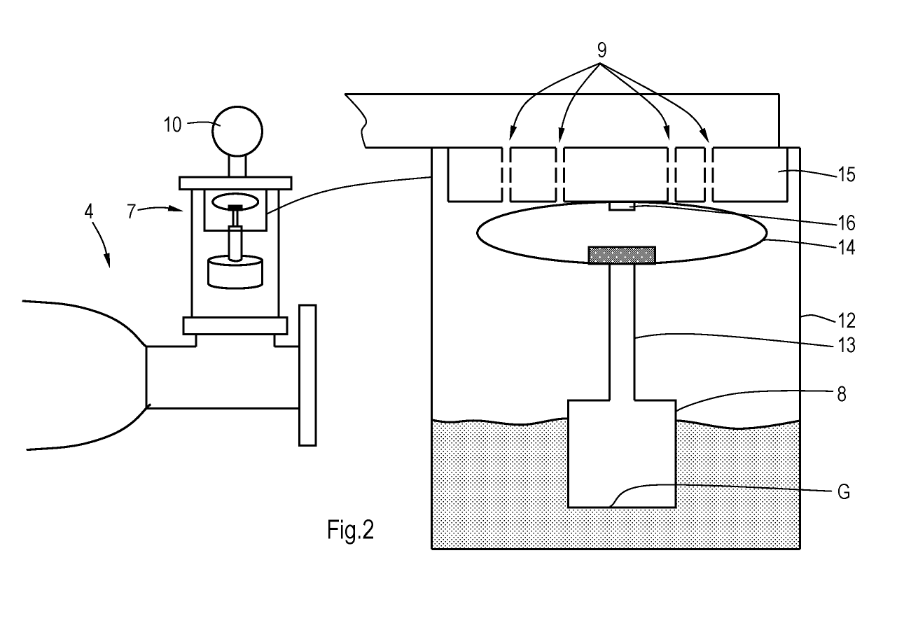

FIG. 2 shows the system according to the invention, in which a valve is depicted in more detail which accommodates its specifically formed float; and

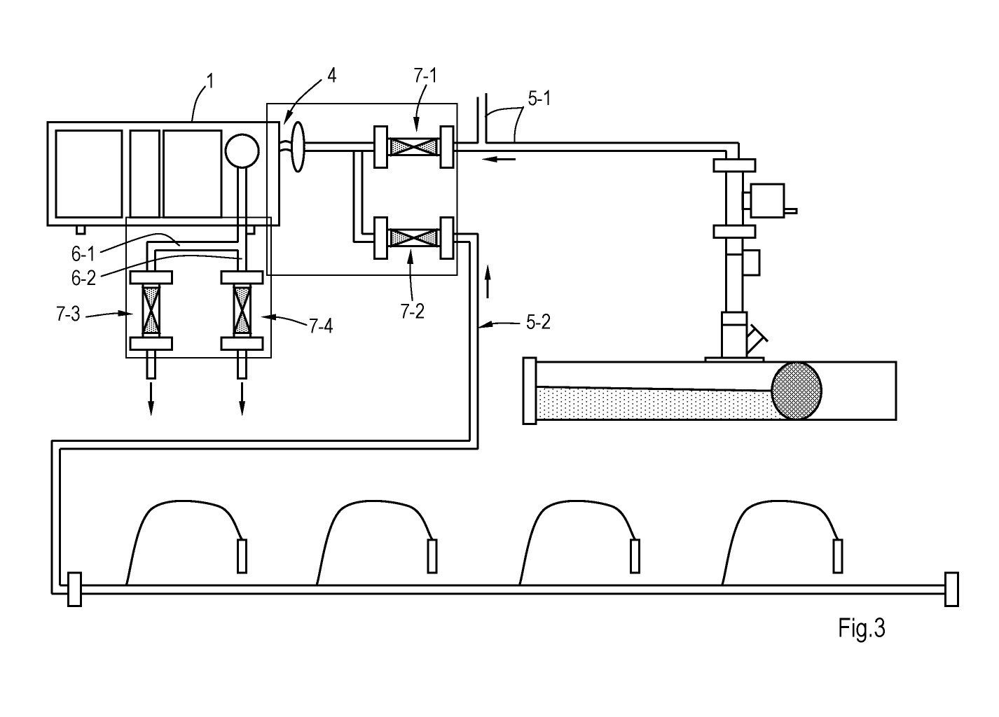

FIG. 3 shows a total system in which the system shown in FIG. 2 is applied.

FIG. 1 schematically shows a part of a pump system 1 which is known per se, which pump system is built up around a not self-priming type of medium pump 2 incorporated in the system 1. In order to start well, such a pump 2 requires a sufficient amount of medium, usually a fluid, hereinafter referred to as water, around its so-termed eye 3. Examples thereof include a turbo pump, a vortex pump, a centrifugal pump or a vane-cell pump. After starting the pump, water in the pump head 4, which includes the part of the supply pipe 5 directly connected to said pump head, is pumped out through drainage pipes 6.

The system 1 further comprises a valve 7, shown in more detail in FIG. 2, which is coupled to the pump head 4, said valve comprising a passage 9 actuated by means of a float 8, which will be explained in more detail, and an air pump 10, only shown schematically, which is connected at the upper side of the valve 7. The air pump 10, which may be a vacuum pump, will be combined, in practice, with a driving unit 11, which is also used to drive the medium pump 2.

If required, the system 1 further comprises sensors, not shown, which are provided at various locations and which are used as the measuring appliances for, usually, computer-controlled or PLC-controlled known control units which control and regulate the setting in operation and proper functioning of the various parts of the system 1. The operation of the system 1 has been explained hereinbefore with reference to the prior art document US-2002/0168270, and hence has not been repeated here.

By means of the float 8, the level of the medium in the pump head 4 is regulated, and the float 8 is shaped such that, when the pump head 4 is filled with medium, the increase of the upward force of the float is sufficient to close the passage 9 in time, so that the medium does not enter the air pump 10, as this can adversely affect the intended operation thereof, resulting eventually in a shorter service life of the air pump.

In the above-mentioned prior art, the float was ball-shaped. In investigations it was found that, if a ball with a certain radius has sunk to a certain maximum depth in a liquid, the submerged volume of the ball, which determines the upward force which it undergoes, is insufficient to rapidly and sufficiently powerfully close off the passage 9. The shape of the float should be such that, when the pump head 4 is being filled with the medium, the increasing upward force of the float is sufficient to close the passage 9 in time. In other words, the change of the volume of the float as a function of the abovementioned depth must vary such that the resulting upward force is sufficient and changes sufficiently rapidly when the water enters the head 4 and the valve housing 12. If this is the case, the float 8 can timely close, through the tappet 13 connected therewith and the valve body 14, the passage 9.

It has further been found that, if the base G of the float 8 contacting the water is substantially flat, the desired result is achieved. This condition is met by a float 8 which, for example, is substantially block-shaped, box-shaped or cylinder-shaped. The inside diameter of the valve housing 12 is preferably adapted to the shape of the float 8 used. By virtue thereof, splashing of water in the housing 12 is counteracted and the valve 7 remains compact.

In practice it has been found to be desirable that the passage is formed by several apertures 9 having, if necessary, different sectional dimensions and/or different mutual distances, or being arranged according to a certain pattern. By virtue thereof, the closing and opening of the passage 9 in the sometimes very virulent environment in which several cubic meters of water and air per minute are displaced, can take place in a rather dosed manner. Such successive opening and closing can be achieved using a flexible valve body 14 which is operated by the float 8 and which is designed to successively open and close the apertures 9. The flexible valve body 14 shown in FIG. 2 forms a closed band which, on the one hand, is attached to the end of the tappet 13 and, on the other hand, is secured to a plate 15 in which the apertures 9 are provided in two sections on either side of a fastening strip 16.

FIG. 3 shows a complete system in which the system around the not self-priming medium pump 2 can be applied. The system shown comprises medium-supply pipes 5-1, 5-2 originating from separate sources, which pipes are jointly connected to the pump head 4 of the medium pump 2 usually through sensor-controlled valves 7-1, 7-2. By virtue of this possibility, the system is very versatile, as, for example, dirty water can be handled by the same system as comparatively clean water. For example, a dirty-water system can be temporarily coupled to such an already present clean-water system. By successively driving the individual, controllable valves 7-1, 7-2 in a suitable manner, it is possible to switch over either to one system or to the other system. Said switching over can be performed as a function of time or, depending on the requirements, in a controlled manner by means of fluid sensors.

If such a system requires separate drainage of dirty water and clean water, then controllable valves 7-3, 7-4, are installed in separate drainage pipes 6-1, 6-2. The valves 7-1, 7-2, 7-3, 7-4 are opened and closed in such a manner and order that the media originating from the separate sources, after being pumped by the only medium pump 2, are advantageously pumped out separately through each of the separate drainage pipes 6-1, 6-2.

The abovementioned sources relate, for example, usually to dirty water which is released when pipes are unblocked (NL-2008388), branched off (NL-2010731), or when excess water is drained (NL-2010732), or when pipes are repaired or provided with temporary features (EP-2.456.926 A1).

1-15. (canceled)

16. A system comprising:
a not self-priming medium pump including a pump head for supply of medium;
a valve coupled to the pump head and which includes a passage operated by a float; and
an air pump connected to the valve;
wherein the system is configured to control a level of the medium in the pump head by the float, and the float is shaped such that, when the pump head is filled with medium, increasing upward force of the float is sufficient close the passage in time.

17. The system according to claim 16, wherein a base of the float contacting the medium is substantially flat.

18. The system according to claim 16, wherein the float is block-shaped or box-shaped.

19. The system according to claim 16, wherein the float is cylinder-shaped.

20. The system according to claim 16, wherein the passage is formed by a plurality of apertures, which may be different in section and/or located at mutually different distances from one another, or arranged according to a certain pattern.

21. The system according to claim 16, wherein the valve includes a flexible valve body which is movably actuated by the float through a tappet, which valve body serves to successively open or close the apertures.

22. The system according to claim 21, wherein the valve includes a fastening member for the flexible valve body, which fastening member divides the apertures into plural sections.

23. The system according to claim 16, further comprising medium-supply pipes originating from separate sources, which pipes are jointly connected to the pump head of the medium pump through sensor-controlled valves.

24. The system according to claim 23, wherein the respective supply pipes are connected to at least one waste water system, or a temporarily or not temporarily functioning waste water or pressure sewage system, or at least one clean water system, or a water drainage system, or a well-point de-watering system.

25. The system according to claim 16, comprising plural separate drainage pipes connected to the pump head of the medium through sensor-controlled valves.

26. The system according to claim 23, wherein the valves are successively opened and closed such that after the medium originating from separate sources has been pumped by the medium pump, the medium is pumped out through the separate drainage pipes.

27. The system according to claim 16, wherein the medium pump is a turbo pump, a vortex pump, a centrifugal pump, or a vane-cell pump.

28. The system according to claim 16, wherein the air pump is a vacuum pump.

29. A valve suitable for use in the system according to claim 16, the valve including a valve housing which is to be filled with a medium, and in which valve housing one or more apertures are closed by a float which floats in the medium and which is subject to an upward force, wherein the float is shaped such that, when the valve housing is filled with the medium, the increasing upward force of the float is sufficient to at least close the one or more apertures.

30. The valve according to claim 29, wherein an interior of the valve housing is cylindrical in section and the valve comprises a cylindrical float which can move in the valve housing.
